(19) United States
(12) Patent Application Publication
(10) Pub. No.: US 2013/0069890 A1
(43) Pub. Date: Mar. 21, 2013

(54) TOUCH DISPLAY DEVICE AND A METHOD OF MANUFACTURING THE SAME

(71) Applicants: YUH-WEN LEE, Zhubei City (TW); Yau-Chen Jiang, Zhubei City (TW); Pingping Huang, Sanming City (CN); Jianxing Luo, Jianyang City (CN)

(72) Inventors: YUH-WEN LEE, Zhubei City (TW); Yau-Chen Jiang, Zhubei City (TW); Pingping Huang, Sanming City (CN); Jianxing Luo, Jianyang City (CN)

(21) Appl. No.: 13/559,532

(22) Filed: Jul. 26, 2012

(30) Foreign Application Priority Data
Sep. 18, 2011 (CN) 201110289572.2

(51) Int. Cl. G06F 3/041; B32B 37/06; B32B 37/12

(52) U.S. Cl. 345/173; 156/60; 156/275.5

(57) ABSTRACT

The present disclosure relates to a touch display device and a method of manufacturing the same. The touch display device comprises a touch panel, a display module and a first adhesive layer formed by an ultraviolet-curing liquid adhesive, wherein the first adhesive layer laminates the touch panel and the display module. The touch display device further comprises of a lens and a second adhesive layer, wherein the second adhesive layer laminates the touch substrate layer and the lens. The present disclosure overcomes shading effect by curing the first adhesive layer and the second adhesive layer by adjusting the order of laminating the display module with the touch substrate and the lens so as to improve yield of lamination between the touch panel and the display module.

This application claims the benefit of Chinese application No. 201110289572.2, filed on Sep. 18, 2011.

### FIELD OF THE INVENTION

The present disclosure relates to touch technology, and more particularly to a touch display device and a method of manufacturing the same.

### BACKGROUND OF THE INVENTION

Conventional touch display devices usually comprise of a touch panel and a display module. The touch panel mainly comprises a touch substrate and a lens, and a touch sensing layer is formed on the surface of the touch substrate. In a standard production process, a lens and a touch substrate are usually laminated first to form a touch panel, and then the touch panel and a display module are laminated. When laminating the touch panel and the display module, a light-curing liquid adhesive is used. On the edge of the lens of a touch display device, there is a printing ink layer which has characteristics of light shading, which causes incomplete curing of the light-curing liquid adhesive because part of the light-curing liquid adhesive is shaded. Shading affects bonding between the liquid adhesive and leads to reduction in yield of lamination between the touch panel and the display module.

### SUMMARY OF THE INVENTION

An objective of the present disclosure is to provide a touch display device and a method of manufacturing the same. The disclosure further relates to complete curing of a light-curing liquid adhesive by changing the order of lamination of a display module, a touch substrate, and a lens so as to improve the yield of lamination between the touch panel and the display module.

A method of manufacturing a touch display device comprises of:

step (a): laminating a display module to a surface of a touch substrate by a first liquid adhesive; and

step (b): laminating a lens to the other surface of the touch substrate by a second liquid adhesive.

In an embodiment, the first liquid adhesive is a light-curing liquid adhesive. The second liquid adhesive is also a light-curing liquid adhesive. The light-curing liquid adhesive includes an ultraviolet-curing liquid adhesive, a heat-induced ultraviolet-curing liquid adhesive, and a moisture-induced ultraviolet-curing liquid adhesive

In an embodiment, first liquid adhesive can be applied on specific portions between display module and touch substrate instead of applying on complete area. Similarly, second liquid adhesive can be applied on specific portions between lens and the touch substrate instead of applying on complete area.

Between the step (a) and the step (b), the method of manufacturing a touch display device further comprises of a step (c): performing light curing of the first liquid adhesive to form a first adhesive layer.

After the step (b), the method of manufacturing a touch display device further comprises a step (d): performing light curing of the second liquid adhesive to form a second adhesive layer.

In an embodiment, if the first and the second liquid adhesives are heat-induced ultraviolet-curing liquid adhesives, the light curing operation further comprises:

performing light curing of the heat-induced ultraviolet-curing liquid adhesive by an ultraviolet light; and

strengthening curing of the heat-induced ultraviolet-curing liquid adhesive by a heating program.

In another embodiment, if the first liquid adhesive and the second liquid adhesive are moisture-induced ultraviolet-curing liquid adhesives, the light curing operation further comprises:

performing light curing of the moisture-induced ultraviolet-curing liquid adhesive by an ultraviolet light; and

strengthening curing of the moisture-induced ultraviolet-curing liquid adhesive by moisture.

The method of manufacturing the touch display device further comprises the step of laminating a flexible circuit board to a touch substrate.

A touch display device of the present disclosure comprises of a touch substrate, a display module and a first adhesive layer, wherein the first adhesive layer laminates the touch substrate and the display module.

The first adhesive layer is formed by an ultraviolet-curing liquid adhesive.

The touch display device further comprises: a lens and a second adhesive layer, wherein the second adhesive layer laminates the touch substrate layer and the lens, and a shading layer is formed around the lens.

A touch sensing layer and a surrounding circuit layer, which is electrically connected to the touch sensing layer are formed on the touch substrate.

Above-mentioned method allows manufacturing of a touch display device, wherein the touch substrate is substantially transparent and there is no shading caused by the shading layer on the edge of the lens such that ultraviolet light can pass through and completely irradiate the liquid adhesive, which can make the ultraviolet-curing liquid adhesive completely light-cured, thereby improving the yield of lamination between the touch panel and the display module.

### BRIEF DESCRIPTION OF THE DRAWINGS

FIG. 1 is a schematic structural view of a touch display device in accordance with embodiments of the present disclosure;

FIG. 2 is a flowchart of a method of manufacturing a touch display device in accordance with embodiments of the present disclosure.

### DETAILED DESCRIPTION OF THE EMBODIMENTS

Detailed description for technical characteristics and advantages of the present disclosure will be disclosed in the following embodiments combined with drawings. It should be noted that in a circumstance of no further description, the elements, structures and characteristics of one embodiment can be combined with other embodiments.

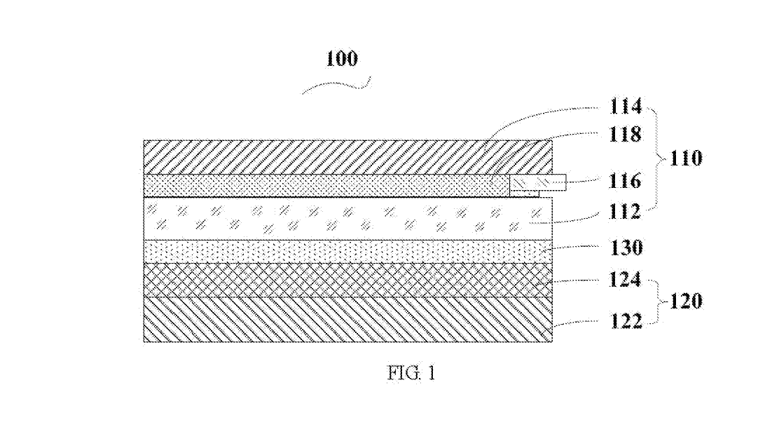

Referring to FIG. 1, a touch display device 100 in accordance with the embodiment comprises a touch panel 110, a display module 120 and a first adhesive layer 130 which laminates the touch panel 110 and the display module 120. The first liquid adhesive layer 130 can be formed by curing one or more of an ultraviolet-curing liquid adhesive, a heat-induced ultraviolet-curing liquid adhesive, or a moisture-induced ultraviolet-curing liquid adhesive. Preferably, an ultraviolet-curing liquid adhesive is used. The ultraviolet-curing liquid adhesive is a liquid adhesive which can be cured into a solid state under irradiation of ultraviolet light of a proper wavelength, wherein the liquid adhesive could either be an acrylic or a silicon-based product.

The touch panel 110 comprises a touch substrate 112, a lens 114, and a second adhesive layer 118, which laminates the touch substrate 112 and the lens 114. A shading area (not shown in FIG. 1) is formed by covering printing ink around the lens 114, and a touch sensing layer (not shown in FIG. 1) is formed on the surface of the touch substrate 112. The touch panel 110 further comprises of a flexible circuit board 116 which is laminated on to the touch substrate 112. A surrounding circuit layer (not shown in FIG. 1) can further be disposed on the touch substrate 112. The touch sensing layer is electrically connected to the surrounding circuit layer, and the surrounding circuit layer is electrically connected to the flexible circuit board 116.

The lens 114 can be made of a glass, plastic or any other material and disposed to protect the touch display device 100 and improve strength of the touch display device 100. The touch substrate 112 is an element disposed to realize the touch technology and can be made of a transparent ITO (Indium Tin Oxide) glass or a film which is processed by a thin-film technology. The touch substrate 112 can be a resistive touch substrate or a capacitive touch substrate. The flexible circuit board 116 is a bridge connecting the touch substrate layer 112 and the touch system, wherein the flexible circuit board 116 usually comprises of an IC (integrated circuit) and other elements, which can compute collected touch information. The second adhesive layer 118 can be formed by curing of one or more of an ultraviolet-curing liquid adhesive, a heat-induced ultraviolet-curing liquid adhesive, or a moisture-induced ultraviolet-curing liquid adhesive. Preferably, the heat-induced ultraviolet-curing liquid adhesive or the moisture-induced ultraviolet-curing liquid adhesive is used.

The heat-induced ultraviolet-curing liquid adhesive is a liquid adhesive which can be cured into a solid state under irradiation of an ultraviolet light of a proper wavelength, and the area that is not irradiated by the ultraviolet light can then be cured by heat. The moisture-induced ultraviolet-curing liquid adhesive is a liquid adhesive which can be cured into a solid state under the irradiation of an ultraviolet light of a proper wavelength, and the area that is not irradiated by the ultraviolet light can then be cured by moisture. The heat-induced ultraviolet-curing liquid adhesive or the moisture-induced ultraviolet-curing liquid adhesive can either be acryl-based or silicon-based product.

The display module 120 comprises of a display panel 122 and at least one diffuser 124 which is laminated to the display 122. The first adhesive layer 130 is disposed between the diffuser 124 and the touch substrate 112. The display 122 could be any of liquid crystal display (LCD), organic light-emitting diode display (OLED), interferometric modulator display (IMOD), cathode ray tube display, plasma display or E-paper display.

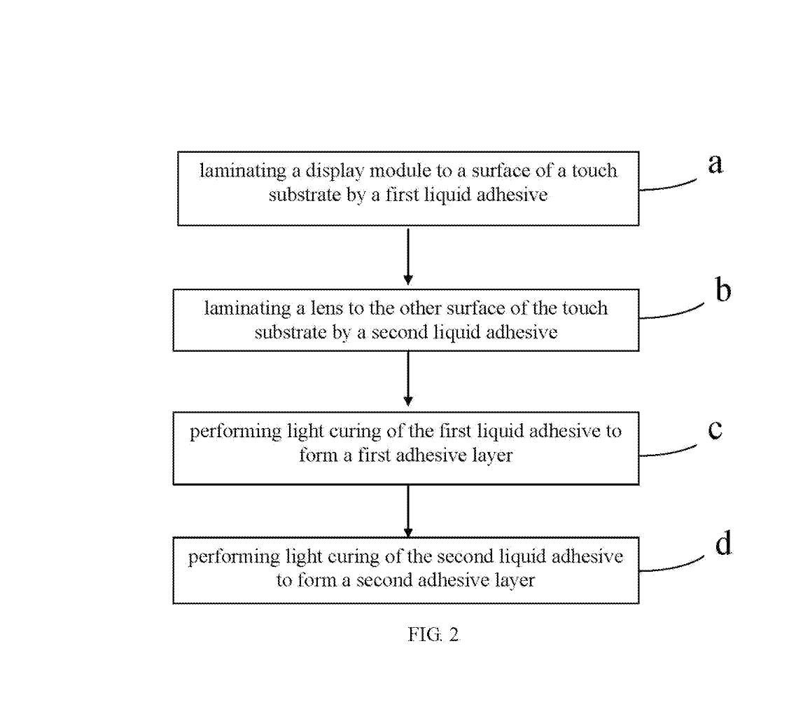

FIG. 2 shows a flowchart for a method of manufacturing a touch display device 100 in accordance with the present embodiments, wherein the method comprises the steps of:

step (a): laminating a display module 120 to a surface of a touch substrate 112 by a first liquid adhesive;

step (b): laminating a lens 114 to other surface of the touch substrate 112 by a second liquid adhesive;

step (c): performing light curing of the first liquid adhesive to form a first adhesive layer 130; and

step (d): performing light curing of the second liquid adhesive to form a second adhesive layer 118.

The first liquid adhesive and the second liquid adhesive are light-curing liquid adhesives including but not limited to ultraviolet-curing liquid adhesive, heat-induced ultraviolet-curing liquid adhesive, or moisture-induced ultraviolet-curing liquid adhesive.

In an embodiment, if heat-induced ultraviolet-curing liquid adhesive is used, the method of light curing comprises:

performing light curing of the heat-induced ultraviolet-curing liquid adhesive by ultraviolet light; and

strengthening curing of the heat-induced ultraviolet-curing liquid adhesive by a heating program, wherein the heating program can be a well known and conventional heating mechanism.

In an embodiment, if moisture-induced ultraviolet-curing liquid adhesive is used, the method of light curing comprises:

performing light curing of the moisture-induced ultraviolet-curing liquid adhesive by ultraviolet light; and

strengthening curing of the moisture-induced ultraviolet-curing liquid adhesive by moisture.

In step (a) of FIG. 2, a flexible circuit board 116 can be laminated to the touch substrate 112 first and then the touch substrate 112 alongwith the flexible circuit board 116 can be laminated to the display module 120.

When the touch panel and the display module are laminated by a conventional method, ultraviolet light is unable to pass through the shading layer formed by printing ink on the lens, leading to incomplete light curing of the light-curing liquid adhesive under the printing ink of the lens. An advantage of using the present method is that the touch substrate layer and the flexible circuit board are substantially transparent, such that the ultraviolet-curing liquid adhesive can be completely light-cured to form an adhesive layer through ultraviolet irradiation. Moreover, there is no influence of printing ink on the lens, and therefore the ultraviolet-curing liquid adhesive is completely light-cured.

Although the present disclosure has been described with reference to the embodiments and the best mode, it is apparent to those skilled in the art that a variety of modifications and changes can be made without departing from the scope of the present disclosure, which is defined by the appended claims.

What is claimed is:

1. A method of manufacturing a touch display device, comprising the steps of:
laminating a display module to a surface of a touch substrate by a first adhesive; and
laminating a lens to other surface of the touch substrate by a second adhesive.

2. The method of manufacturing a touch display device as claimed in claim 1, wherein the first adhesive is a light-curing liquid adhesive.

3. The method of manufacturing a touch display device as claimed in claim 1, wherein the second adhesive is a light-curing liquid adhesive.

4. The method of manufacturing a touch display device as claimed in claim 2, wherein the light-curing liquid adhesive is selected from a group comprising of an ultraviolet-curing liquid adhesive, a heat-induced ultraviolet-curing liquid adhesive, a moisture-induced ultraviolet-curing liquid adhesive, or a combination thereof.

5. The method of manufacturing a touch display device as claimed in claim 3, wherein the light-curing liquid adhesive is selected from a group comprising of an ultraviolet-curing liquid adhesive, a heat-induced ultraviolet-curing liquid adhesive, a moisture-induced ultraviolet-curing liquid adhesive, or a combination thereof.

6. The method of manufacturing a touch display device as claimed in claim 1, further comprising a step (c) between the step (a) and the step (b): performing light curing of the first adhesive to form a first adhesive layer.

7. The method of manufacturing a touch display device as claimed in claim 1, further comprising a step (d) after the step (b): performing light curing of the second adhesive to form a second adhesive layer.

8. The method of manufacturing a touch display device as claimed in claim 6, wherein if the first adhesive and the second adhesive are heat-induced ultraviolet-curing liquid adhesives, the light curing operation further comprises:
performing light curing of the heat-induced ultraviolet-curing liquid adhesive by ultraviolet light; and
strengthening curing of the heat-induced ultraviolet-curing liquid adhesive by a heating program.

9. The method of manufacturing a touch display device as claimed in claim 7, wherein if the first adhesive and the second adhesive are heat-induced ultraviolet-curing liquid adhesives, the light curing operation further comprises:
performing light curing of the heat-induced ultraviolet-curing liquid adhesive by ultraviolet light; and
strengthening curing of the heat-induced ultraviolet-curing liquid adhesive by a heating program.

10. The method of manufacturing a touch display device as claimed in claim 6, wherein if the first adhesive and the second adhesive are moisture-induced ultraviolet-curing liquid adhesives, the light curing operation further comprises:
performing light curing of the moisture-induced ultraviolet-curing liquid adhesive by ultraviolet light; and
strengthening curing of the moisture-induced ultraviolet-curing liquid adhesive by moisture.

11. The method of manufacturing a touch display device as claimed in claim 7, wherein if the first adhesive and the second adhesive are moisture-induced ultraviolet-curing liquid adhesives, the light curing operation further comprises:
performing light curing of the moisture-induced ultraviolet-curing liquid adhesive by ultraviolet light; and
strengthening curing of the moisture-induced ultraviolet-curing liquid adhesive by moisture.

12. The method of manufacturing a touch display device as claimed in claim 1, further comprising a step of laminating a flexible circuit board to the touch substrate.

13. A touch display device comprising:
a touch substrate;
a display module, laminated to a surface of the touch substrate by a first adhesive layer; and
a lens, laminated to the other surface of the touch substrate by a second adhesive layer.

14. The touch display device as claimed in claim 10, wherein the first adhesive layer and the second adhesive layer is selected from a group comprising of an ultraviolet-curing liquid adhesive, a heat-induced ultraviolet-curing liquid adhesive, a moisture-induced ultraviolet-curing liquid adhesive, and a combination thereof.

15. The touch display device as claimed in claim 11, wherein the first adhesive layer is an acrylic or a silicon-based product.

16. The touch display device as claimed in claim 11, wherein the second adhesive layer is an acrylic or a silicon-based product.

17. The touch display device as claimed in claim 10, wherein a shading layer is formed around the lens.

18. The touch display device as claimed in claim 10, wherein a touch sensing layer, and a surrounding circuit layer electrically connected to the touch sensing layer are formed on the touch substrate.
